(19) United States
(12) Patent Application Publication
(10) Pub. No.: US 2022/0176392 A1
(43) Pub. Date: Jun. 9, 2022

(54) PNEUMATIC SPRAY GUN CARTRIDGE

(71) Applicant: PPG Architectural Finishes, Inc., Pittsburgh, PA (US)

(72) Inventors: Randal W. Hanson, Seven Fields, PA (US); Christopher R. Hamlin, Seattle, WA (US)

(73) Assignee: PPG Architectural Finishes, Inc., Pittsburgh, PA (US)

(21) Appl. No.: 17/600,697

(22) PCT Filed: Mar. 27, 2020
(86) PCT No.: PCT/US20/25451

§ 371 Date: Oct. 1, 2021

Related U.S. Application Data
(60) Provisional application No. 62/827,470, filed on Apr. 1, 2019.

(51) Int. Cl. B05B 7/24; B05B 12/00

(52) U.S. Cl. CPC B05B 7/2424; B05B 12/002; B05B 7/2416

(57) ABSTRACT

Pneumatic spray gun (10) and cartridge tip assemblies for applying sprayable materials to various surfaces are disclosed. A tube of flowable texture material to be sprayed having a cartridge tip (100) may be loaded into a pressure canister of a texture material spray gun (10). The cartridge tip (100) may include radially outwardly extending ribs (130), radially inwardly extending recesses and/or other features that engage with corresponding features of the spray nozzle assembly to reduce or prevent relative rotation between the cartridge tip (100) and the spray nozzle assembly.

### CROSS-REFERENCE TO RELATED APPLICATION

This application claims the benefit of U.S. Provisional Patent Application Ser. No. 62/827,470, filed on Apr. 1, 2019, which is incorporated herein by reference.

### FIELD OF THE INVENTION

The present invention relates to pneumatic material spray gun cartridge assemblies.

### BACKGROUND OF THE INVENTION

Textured materials such as drywall and texture paints are typically applied to surfaces using aerosol spray cans, hopper guns and hopper rigs. However, aerosol cans have limited areas of coverage, and hopper guns and rigs have limitations.

PCT Application No. PCT/US18/67987 filed Dec. 28, 2018 entitled “Pneumatic Material Spray Gun,” which is incorporated herein by reference, discloses pneumatic spray gun systems for various types of materials including textured drywall formulations and texture paint.

### SUMMARY OF THE INVENTION

The present invention provides a cartridge for containing and dispensing texture materials from a texture material spray gun. The cartridge comprises a generally cylindrical hollow cartridge body, and a cartridge tip extending forwardly along a longitudinal axis from the cartridge body comprising at least one radially projecting rib or at least one radially indented recess structured and arranged to inhibit rotation of the cartridge tip around the longitudinal axis when the cartridge is mounted in the texture material spray gun.

The present invention also provides a pneumatic spray gun nozzle assembly for dispensing texture material. The assembly comprises a spray nozzle including a contoured central nozzle opening, an air nozzle structured and arranged to direct pressurized air toward the texture material as the texture material passes through the spray nozzle, and a cartridge including a contoured cartridge tip insertable in the contoured central nozzle opening. The contoured central nozzle opening comprises at least one retaining recess receiving at least one radially projecting rib of the contoured cartridge tip, or the contoured central nozzle opening comprises at least one retaining rib received within at least one radially indented recess of the cartridge tip, whereby relative rotational movement of the contoured cartridge tip within the contoured central nozzle opening is inhibited by the at least one radially projecting rib received in the at least one retaining recess of the contoured nozzle opening, or by the at least one retaining rib received within the at least one radially indented recess of the contoured cartridge tip.

The present invention further provides a pneumatic spray gun for dispensing texture material. The pneumatic spray gun comprises a pressure canister including an interior volume structured and arranged to receive a cartridge containing the texture material, a spray nozzle adjacent a front end of the pressure canister structured and arranged to receive the texture material when the texture material is dispensed from the cartridge, and an air nozzle structured and arranged to direct pressurized air toward the texture material as the texture materials passes through the spray nozzle. The spray nozzle comprises a contoured central nozzle opening comprising at least one retaining recess or at least one retaining rib structured and arranged to engage a contoured tip of the cartridge to thereby inhibit relative rotational movement between the contoured cartridge tip and the contoured central nozzle opening.

### BRIEF DESCRIPTION OF THE DRAWINGS

FIG. 1 is a side view of a pneumatic material spray gun and cartridge tip assembly in accordance with the present invention.

FIG. 2 is a rear view of the pneumatic material spray gun and cartridge tip assembly of FIG. 1.

FIG. 3 is a side sectional view taken through section 3-3 of FIG. 2

FIG. 4 is a top sectional view taken through section 4-4 of FIG. 1.

FIG. 5 is a front view of the pneumatic material spray gun and cartridge tip assembly of FIG. 1 oriented at a 45-degree angle.

FIG. 6 is an angled sectional view taken through section 6-6 of FIG. 5.

FIG. 7 is a rear isometric view of a nozzle assembly of the pneumatic material spray gun of FIG. 1 structured and arranged for receiving a contoured cartridge tip in accordance with the present invention.

FIG. 8 is a rear view of the nozzle assembly of FIG. 7.

FIG. 9 is an isometric view of a cartridge tip for use in a pneumatic material spray gun and cartridge tip assembly in accordance with the present invention.

FIG. 10 is a side view;

FIG. 11 is a top view and FIG. 12 is a bottom view of the cartridge tip of FIG. 9.

FIG. 13 is an exploded isometric view of a nozzle assembly for use in a pneumatic spray gun in accordance with the present invention.

FIGS. 14 and 15 are isometric views of nozzle inserts having different sizes of outlet openings in accordance with the present invention.

FIG. 16 is an exploded isometric view of a valve assembly for use in a pneumatic spray gun in accordance with the present invention.

FIG. 17 is a rear view of a valve assembly for use in a pneumatic spray gun in accordance with the present invention.

FIG. 18 is a side sectional view taken through section 18-18 of FIG. 17.

FIG. 19 is a side sectional view taken through section 19-19 of FIG. 17.

FIG. 20 is a side sectional view taken through section 20-20 of FIG. 17.

FIG. 21 is a schematic flow diagram illustrating operational features of a pneumatic spray gun in accordance with the present invention.

### DETAILED DESCRIPTION OF THE INVENTION

Pneumatic spray guns and cartridge tip assemblies of the present invention may be used to spray texture materials such as textured drywall and texture paints onto surfaces in various textured patterns. Examples of drywall textures include orange peel, splatter, knock down and acoustic “popcorn” textures. Examples of paint textures include premium 100 percent acrylic paints capable of producing splatter and knockdown textures but durable, so they do not require top coating with a separate coat of paint. Other texture materials that may be sprayed using the pneumatic spray guns and cartridge tip assemblies of the present invention include elastomeric stucco coatings, insulation coatings, sound deadening coatings, automotive/truck bedliner coatings, adhesives and the like.

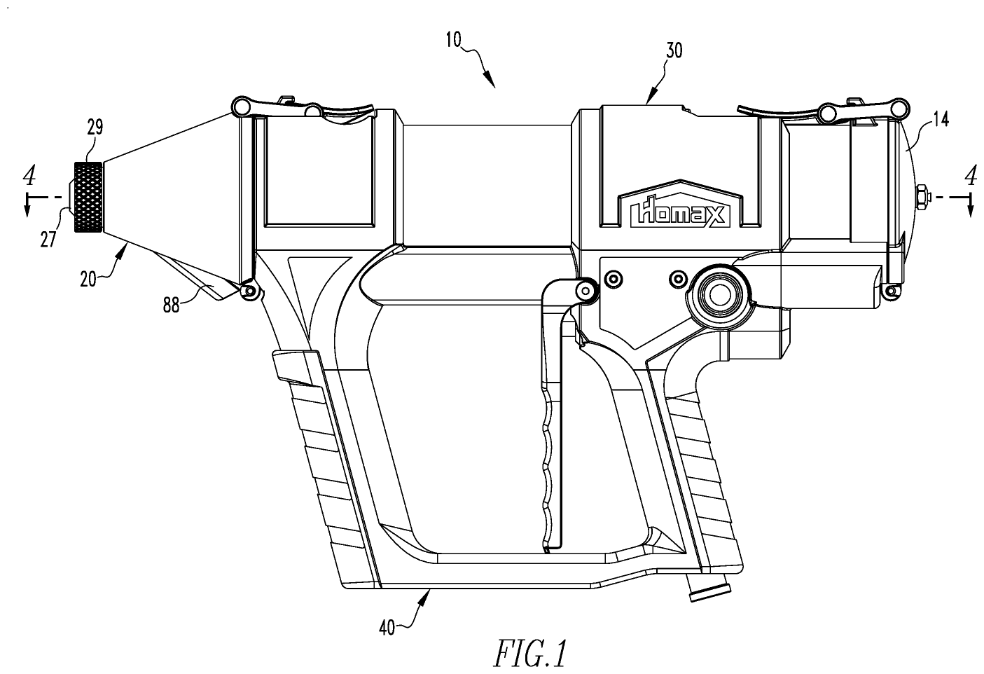

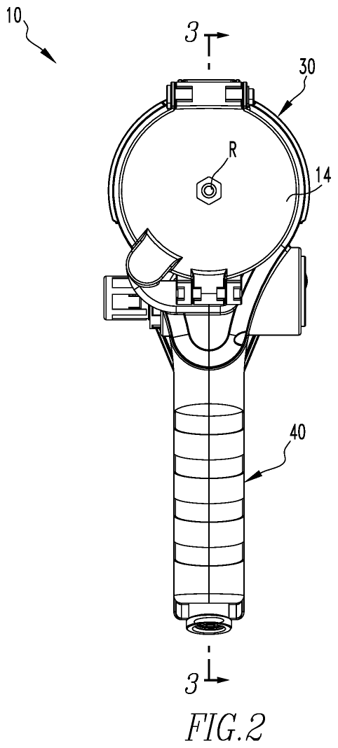

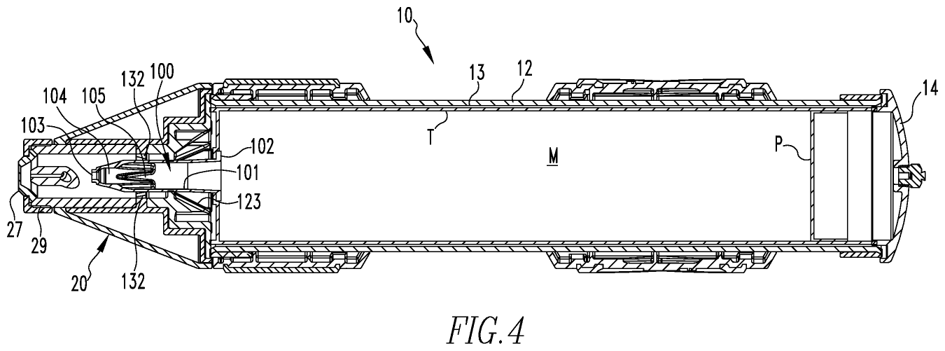

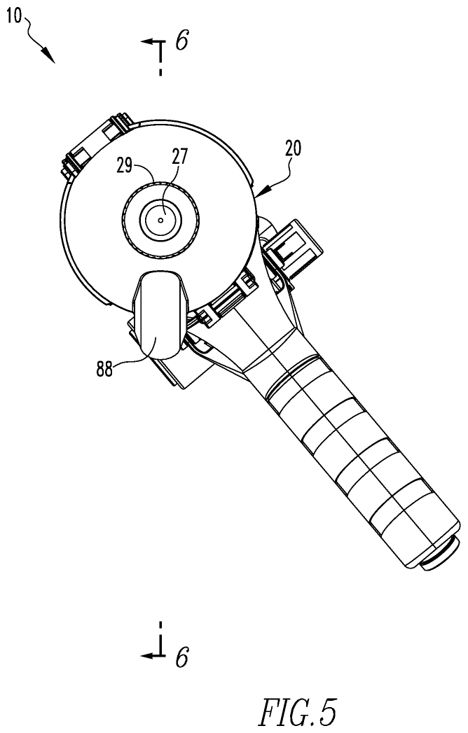

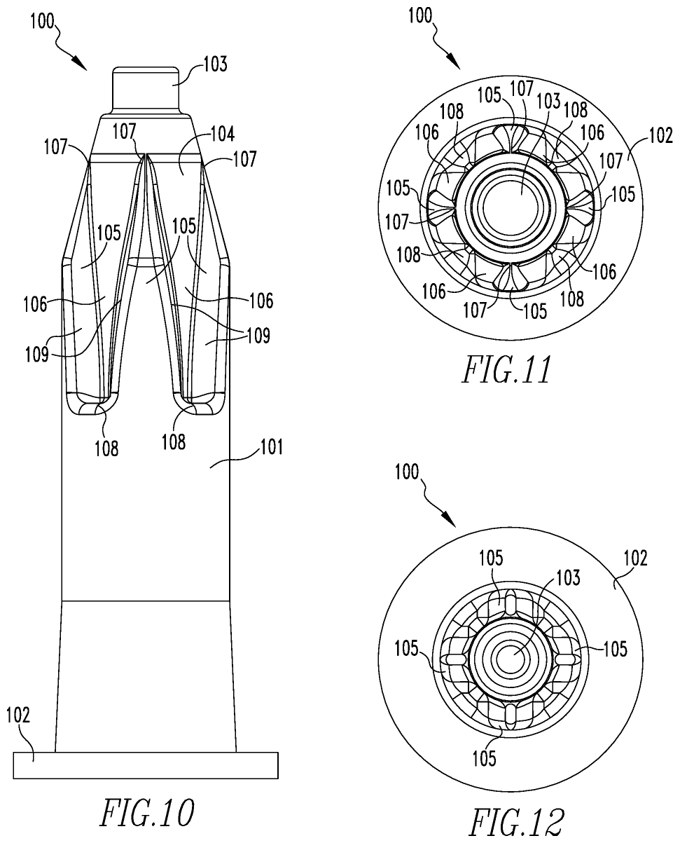

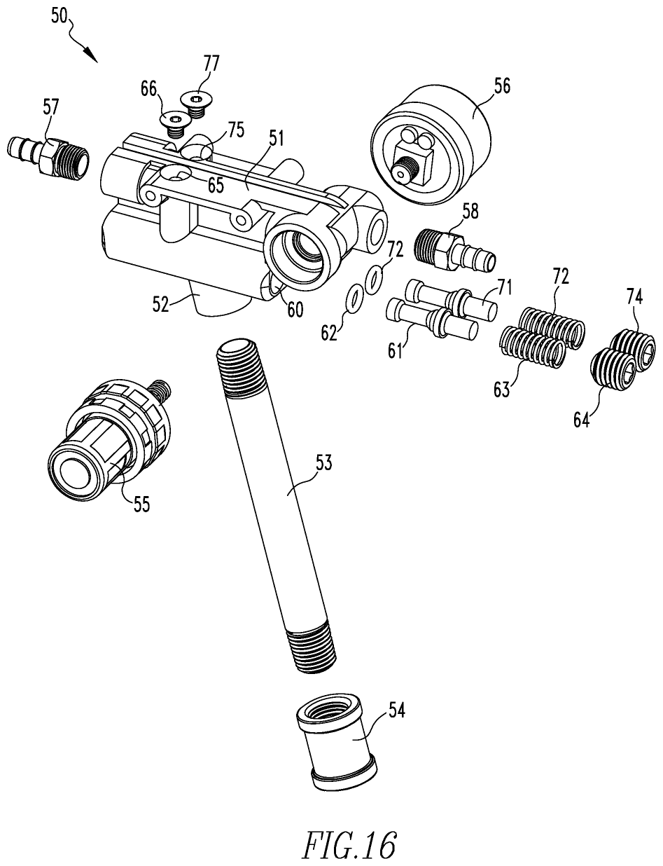

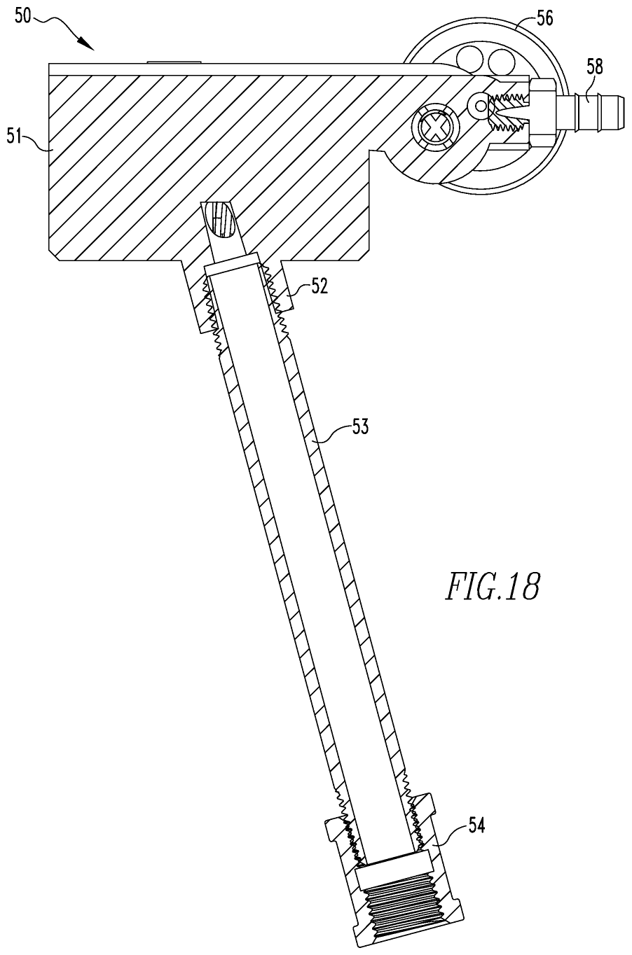

FIGS. 1-21 illustrate a pneumatic spray gun 10, components thereof, and operational features thereof. As more fully described below, cartridge tips 100 of the present invention may be used with the pneumatic spray gun 10. The pneumatic spray gun 10 includes a generally cylindrical pressure cannister 12 with an interior volume 13. A rear hatch assembly 14 is sealingly attached at the rear end of the pressure cannister 12 by a rear pivot mounting 15. A rear closure latch 16 secures the rear hatch assembly 14 in a closed and sealed position on the rear of the pressure cannister 12. A nozzle assembly 20 including a front nose cap 17 is sealingly attached at the front end of the pressure cannister 12 by a front pivot mounting 18. A front closure latch 19 secures the front nose cap 17 in a closed and sealed position on the front of the pressure cannister 12. As more fully described below, the pressure canister 12 may contain a tube T of flowable material M such as liquid drywall formulations, paint texture formulations, liquid adhesive coatings such as fiberglass reinforced plastic adhesives, tile adhesives and flooring adhesives, and slurries such as stucco formulations. During spraying operations, such flowable material M within the pressure canister 12 is subjected to elevated pressures to force the texture material M from the tube T, where it is contacted by a flow of pressurized air to generate a desired texture material spray pattern.

A cartridge or tube T containing texture material M may be inserted in the pressure cannister body 12. The tube T is in the form of a generally cylindrical hollow cartridge body. The tube T has an open rear end fitted with a moveable plunger P which is friction fit into the rear tube opening, thereby containing the material from flowing out the rear of the tube. As more fully described below, a dispensing cartridge tip 100 is provided at the front of the tube T. When pressurized air is delivered into the interior volume 13 of the pressure canister 12, it forces the plunger P forward, causing the texture material M to flow out of the dispensing cartridge tip 100 of the tube T into the nozzle assembly 20, where it merges with a flow of pressurized air to produce a desired texture spray pattern.

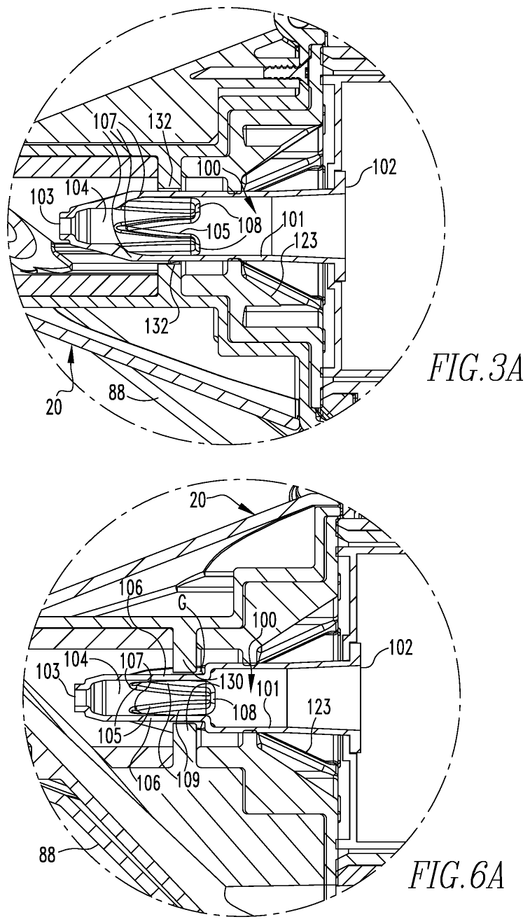

As shown in FIGS. 7, 8 and 13, the nozzle assembly 20 has a generally cylindrical recess 120 extending forward from a rear face 21 of the nozzle assembly 20. A gasket 23 is installed in the cylindrical recess 120 against the rear face 21 to form an airtight seal between the nozzle cap assembly 20 and the front end of the pressure canister 12 when the front nose cap 17 is in its closed position. A cylindrical sleeve is installed in the nozzle assembly 20 forward of the cylindrical recess 120. A nozzle insert 27 is removably seated on the front end of the cylindrical sleeve, and is held on the sleeve by a nozzle retainer 29.

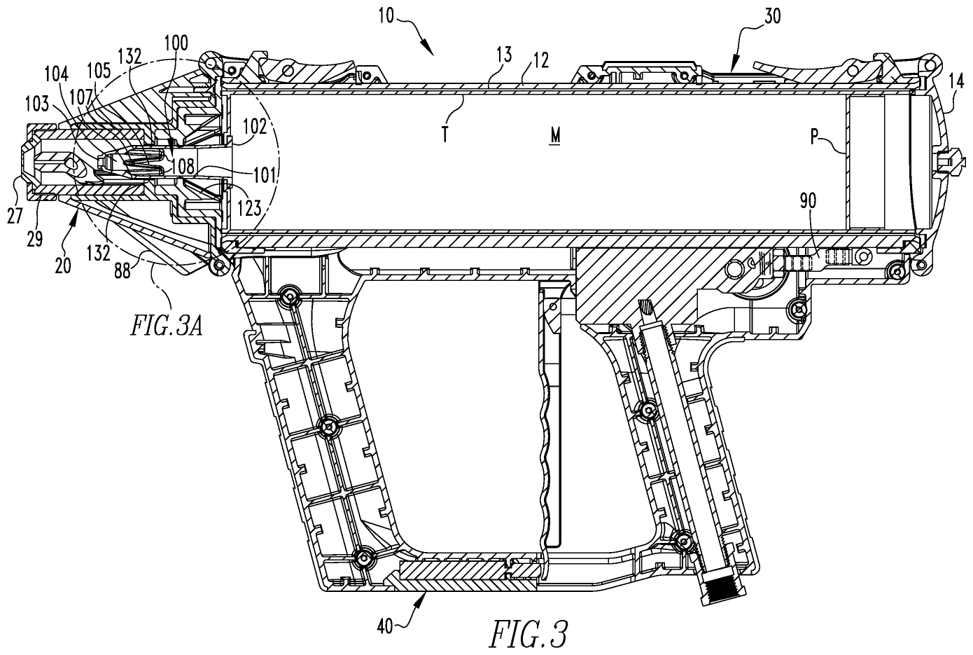

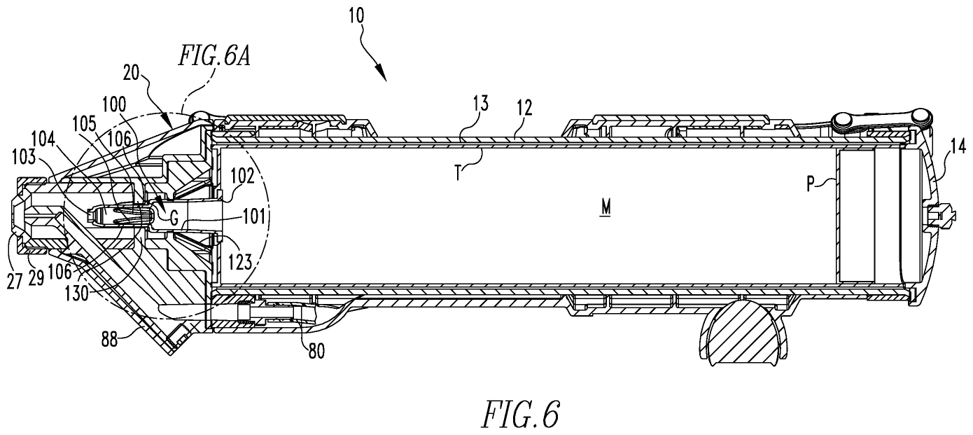

FIGS. 1-8 illustrate details of a nozzle assembly 20 and cartridge tip 100 in accordance with the present invention. As shown in the sectional views of FIGS. 3, 4 and 6, the cartridge tip 100 extends from the tube T into the interior of the nozzle assembly 20. As shown in FIGS. 3, 4, 6 and 9-12, the cartridge tip 100 includes a generally cylindrical body 101, a rear flange 102 that is retained within the tube T, and a front dispensing tip 103. The front dispensing tip 103 is generally cylindrical and has a closed front portion that may be cut off prior to use of the assembly in order to provide an opening having a selected diameter through the front end of the cartridge tip 100. In FIGS. 3, 3A, 6 and 6A, the dispensing tip 103 is shown as being cut off. The cartridge tip 100 includes a cylindrical or slightly tapered front portion 104 extending forwardly from the generally cylindrical body 101. Multiple radially projecting ribs 105 extend forwardly in a longitudinal direction from the body 101 and extend radially outward from the front portion 104. The radially projecting ribs 105 have outer surfaces that taper radially inward toward the dispensing tip 103. The radially projecting ribs 105 define radially indented recesses 106 spaced circumferentially between the radially projecting ribs 105. Four radially projecting ribs 105 are spaced at equal 90-degree intervals around the circumference of the cartridge tip 100, and four radially indented recesses 106 are circumferentially spaced therebetween. However, any other suitable number, spacing, shape or configuration of radially projecting ribs 105 and radially indented recesses 106 may be used. In addition, at least some of the radially projecting ribs 105 may be replaced by radially inwardly projecting recesses into the body 101 or front portion 104.

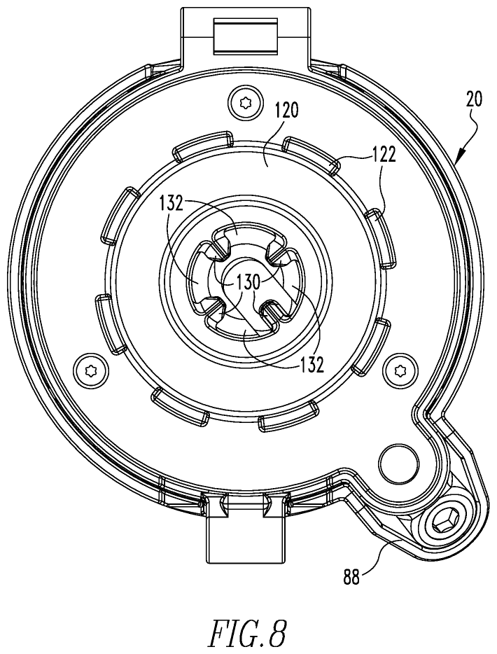

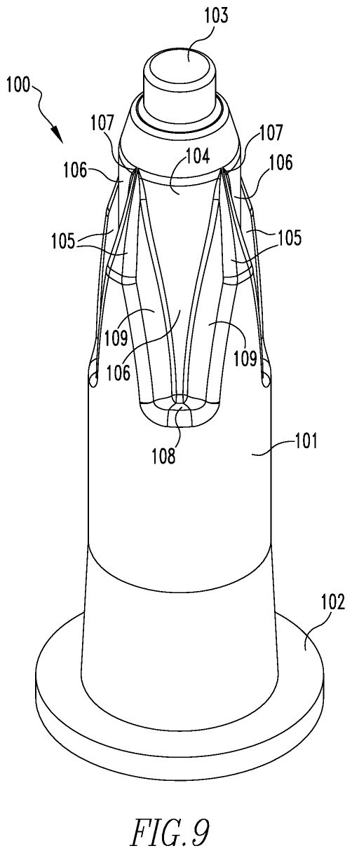

As further shown in detail in FIGS. 9 and 10, the radially projecting ribs 105 include inwardly tapered forward rib tips 107, which facilitate alignment of the radially projecting ribs 105 with the corresponding retaining recesses 132 of the nozzle assembly 20. The forward rib tips 107 may taper inwardly at a greater angle than the taper angle of the remainder of each radially projecting rib 105. Each radially indented recess 106 ends in a rear wall 108, and each radially projecting rib 105 includes side channel walls 109 that transition into the rear walls 108 of the adjacent radially indented recesses 106. The side channel walls 109 extend along the length of the front portion 104 and extend radially inward from the outer surfaces of the radially projecting ribs 105 to form the radially indented recesses 106.

As shown most clearly in FIGS. 6-8, the nozzle assembly 20 includes an interior chamber 120 including multiple radially inwardly extending retaining ribs 130 therein. The radially inwardly extending retaining ribs 130 define retaining recesses 132 spaced circumferentially between the retaining ribs 130. Four retaining ribs 130 and four retaining recesses 132 are provided at equal 90-degree increments around the interior circumference of the interior chamber 120. The retaining ribs 130 are structured and arranged to fit between the radially projecting ribs 105 and within the radially indented recesses 106 of the cartridge tip 100 when it is installed in the nozzle assembly 20. In this manner, the retaining ribs 130 inhibit rotation of the cartridge tip 100 around its longitudinal axis inside the nozzle assembly 20. As used herein, the term “inhibit rotation” means that relative rotation of the cartridge tip 100 and the nozzle assembly 20 is reduced or prevented. Rotation may be inhibited when the cartridge T and cartridge tip 100 have been installed in the pressure canister 12 and nozzle assembly 20 of the spray gun 10, e.g., as shown in FIGS. 3, 4 and 6. In addition, rotation may be inhibited during installation of the cartridge T into the pressure canister 12, in which case the cartridge tip 100 is rotationally aligned in a particular orientation within the nozzle assembly 20 during the installation process. The term “inhibit rotation” thus may include rotational alignment and positioning during installation of the cartridge T in the spray gun 10, as well as retention of the cartridge T and cartridge tip 100 in the spray gun 10 in a particular rotational orientation after installation. Although four retaining ribs 130 and retaining recesses 132 are provided, it is to be understood that any other suitable number, spacing, shape or configuration of retaining ribs and retaining recesses may be used. In addition, some or all of the retaining ribs 130 may be replaced with retaining recesses (not shown) that may extend into the interior wall of the interior chamber 120.

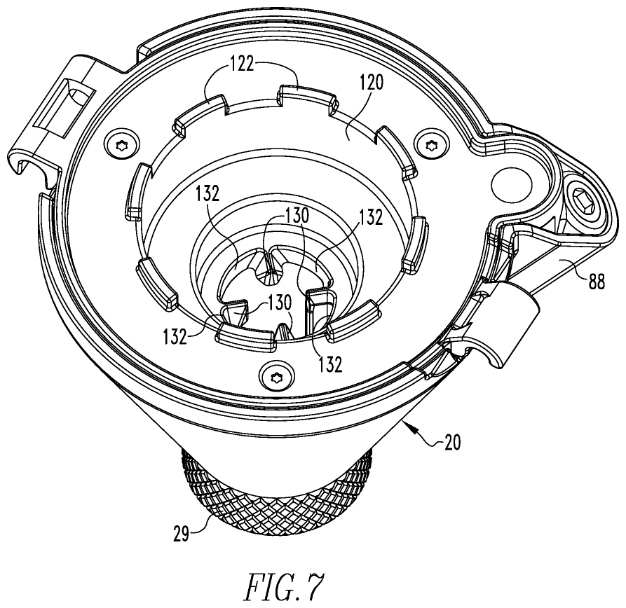

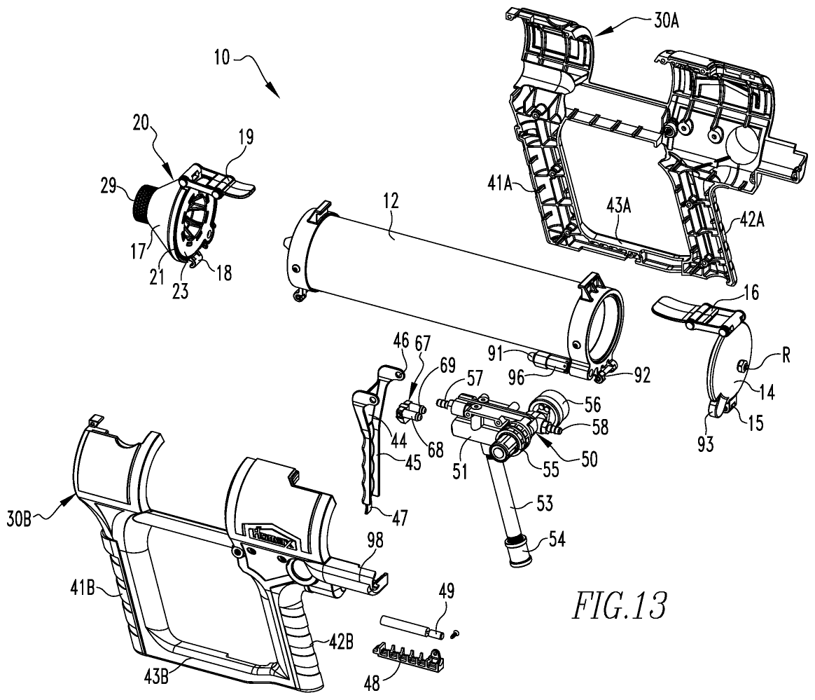

As shown most clearly in FIGS. 7 and 8, multiple axial projections 122 are provided around the circumference of the rear opening of the interior chamber 120. As shown most clearly in FIG. 13, a generally conical-shaped gasket 23 is inserted into the interior chamber 120 of the nozzle assembly 20. The gasket 23 includes multiple slots spaced around the circumference thereof that align with the axial projections 122 of the nozzle assembly 20. It is noted that the gasket 23 is not shown in FIGS. 7 and 8 for purposes of illustrating the interior chamber 120, retaining ribs 130 and recesses 132 of the nozzle assembly 20.

As shown most clearly in FIGS. 3, 4 and 6, the cartridge tip 100 extends through a front opening of the gasket 23 in order to provide a seal or barrier between the exterior surface of the body 101 of the cartridge tip 100 and the front opening of the gasket 23. The gasket 23 performs the function of restricting flow of air and material backward into the pressure tube T and may be made of any suitable material such as thermo plastic rubber (TPR), thermo plastic elastomer (TPE), EPDM, nitrile, silicone, neoprene, viton or the like.

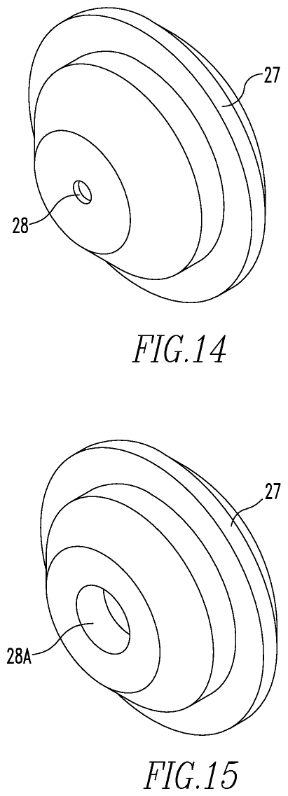

As shown in FIGS. 14 and 15, the nozzle insert 27 may have a nozzle hole 28 of relatively small diameter (FIG. 14) or may have a nozzle hole 28A of relatively large diameter (FIG. 15). For example, the diameters of the nozzle holes may range from 1 to 8 mm, or from 2 to 6 mm. Any suitable number of nozzle inserts 27 having varying nozzle hole sizes may be used.

As shown most clearly in FIG. 13, the pneumatic spray gun 10 includes a housing assembly 30 having a right-side subassembly 30A and a left-side subassembly 30B. When the right-side and left-side subassemblies 30A and 30B are secured together to form the housing assembly 30, a front housing sleeve is provided at the front end of the pressure cannister 12, and a rear housing sleeve is provided at the rear end of the pressure cannister 12. The housing 30 includes a lower spine extending between the front and rear housing sleeves and below the pressure cannister 12.

The pneumatic spray gun 10 includes a trigger handle assembly including a front handle 41, rear handle 42, and bridge 43 connecting the front and rear handles 41 and 42. A trigger 45 is pivotably mounted by a trigger pivot mounting 46 onto the housing 30. A trigger tip 47 is provided at the lower end of the trigger 45. The trigger 45 includes a contact surface 44 that engages a valve actuator assembly 67, as more fully described below. A damper bracket 48 is secured inside the bridge 43, and a damper cylinder and piston assembly 49 is mounted on the damper bracket 48. When the trigger 45 is in a resting or closed position as shown in the figures, the trigger tip 47 contacts the piston of the damper assembly 49. As more fully described below, contact between the damper cylinder and piston assembly 49 and the trigger tip 47 dampens the movement of the trigger 45 when a user releases the trigger 45 and the trigger moves from its open position to its closed position.

As shown most clearly in FIGS. 13 and 16-20, the pneumatic spray gun 10 includes a valve assembly 50 having a valve body 51. Pressurized air may flow into the valve assembly 50 by means of an air inlet sleeve 52, air inlet tube 53, and air inlet fixture 54. A regulator 55 is provided on one side of the valve body 51, and a pressure gauge 56 is provided on the other side of valve body 51. A first pressurized air outlet 57 extends from the front of the valve body 51, and a second pressurized air outlet 58 extends from the rear of the valve body 51. As more fully described below, the first pressurized air outlet 57 feeds a first stream of pressurized air to the front nozzle assembly 20, where it impinges upon the texture material M as it flows from the dispensing tip D to provide a desired spray pattern. The second pressurized air outlet 58, which is in flow communication with the regulator 55, feeds a second supply of pressurized air to the interior volume 13 of the pressure canister 12, where it forces the plunger P forward in the tube T to thereby discharge the texture material M through the dispensing tip D at the front end of the tube T.

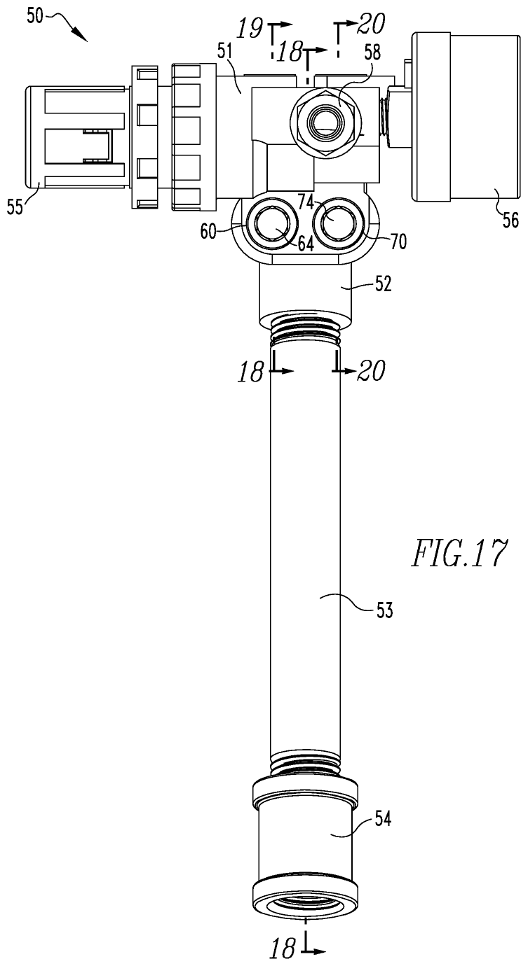

As shown most clearly in FIGS. 17-20, the valve assembly 50 includes a first valve cylinder 60 inside the valve body 51, a first valve plunger 61, a first o-ring 62, a first biasing spring 63, and a first plug screw 64. The valve assembly 50 also includes a second valve cylinder 70 inside the valve body 51, a second valve plunger 71, a second o-ring 72, a second biasing spring 73, and a second plug screw 74.

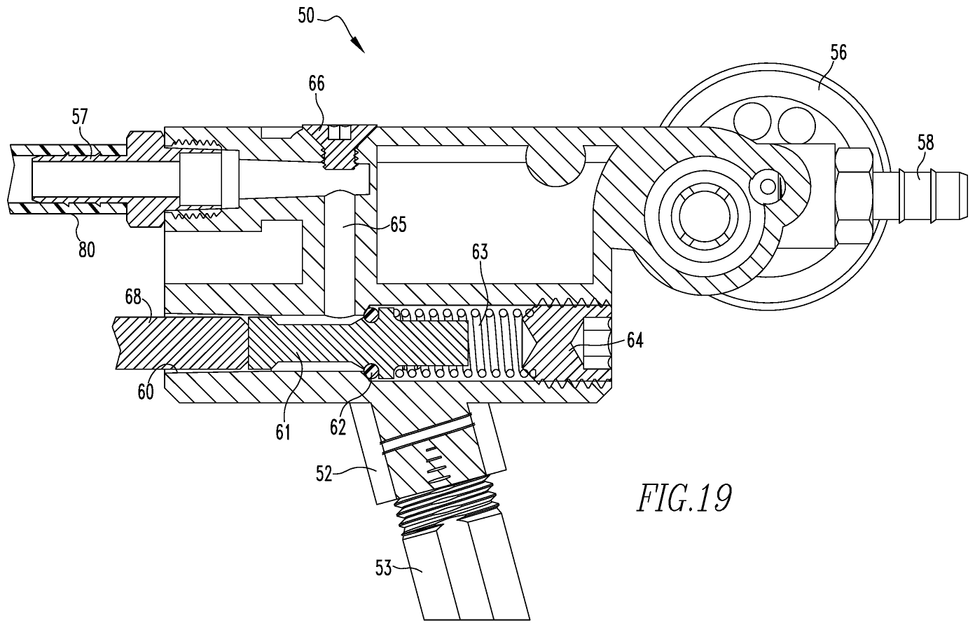

As shown in FIGS. 13, 19 and 20, a valve actuator assembly 67 is located between the contact surface 44 of the trigger 45 and the valve body 51 of the valve assembly 50. The valve actuator assembly 67 includes a first actuator plunger 68 and a second actuator plunger 69. As shown most clearly in FIG. 19, the first actuator plunger 68 of the valve actuator assembly 67 is inserted into the first valve cylinder 60 of the valve assembly 50, where it contacts the first valve plunger 61. The first biasing spring 63 forces the first valve plunger 61 against the first actuator plunger 68. Movement of the first actuator plunger 68 into the first valve cylinder 60 upon squeezing or opening of the trigger 45 and its contact surface 44 moves the first valve plunger 61 into the first valve cylinder 60 against the bias force of the first biasing spring 63 to thereby open the flow of air from the air inlet sleeve 52 into a first pressurized air passage 65. The first pressurized air passage 65 is in flow communication with the first pressurized air outlet 57. A first access screw 66 permits access to the first pressurized air passage 65.

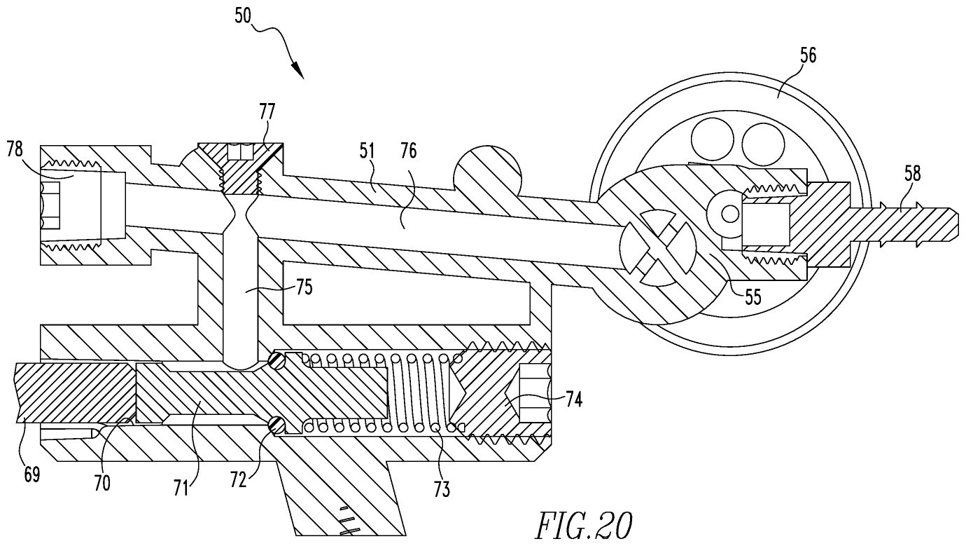

As shown in FIG. 20, the second actuator plunger 69 of the valve actuator assembly 67 is inserted into the second valve cylinder 70 of the valve assembly 50. The second biasing spring 73 forces the second valve plunger 71 against the second actuator plunger 69. Movement of the second actuator plunger 69 into the second valve cylinder 70 upon opening of the trigger 45 and its contact surface 44 causes the second valve plunger 71 to move into the second valve cylinder 70 against the bias force of the second biasing spring 73 to thereby open the flow of pressurized air from the air inlet sleeve 52 into a second pressurized air passage 75. As shown in FIG. 13, the axial length of the second actuator plunger 69 may be shorter than the axial length of the first actuator plunger 68 in order to initiate the flow of the first pressurized air to the nozzle assembly 20 before the flow of the second pressurized air to the interior volume 13 of the pressure canister 12. The different lengths of the first and second plungers 68 and 69 also stops the flow of the second pressurized air prior to stopping the flow of the first pressurized air when a user releases the trigger 45 and it returns toward its closed position. The second pressurized air passage 75 has a branch 76 that is in flow communication with the pressure regulator 55. The second pressurized air outlet 58 is downstream from the pressure regulator 55 and delivers the regulated second pressure to the interior volume 13 of the pressure canister 12, as more fully described below. A second access screw 77 permits access to the second pressurized air passage 75. An access plug 78 provides access to the rear branch 76.

A second pressurized air delivery line 90 extends between the second pressurized air outlet 58 of the valve assembly to an inlet fixture 91 of a commercially available quick exhaust valve 96. As shown in the exploded view of FIG. 13, the quick exhaust valve 96 includes an outlet port 92 in flow communication with an air passage cavity 93 that extends radially outward from the rear hatch assembly 14. The air passage cavity 93 allows the second pressurized air to flow from the second pressurized air outlet 58 through the quick exhaust valve 96 into the rear portion 94 of the interior volume 13 of the pressure canister 12. As further shown in FIG. 13, the pressure relief valve R in the rear hatch assembly 14 may be used to limit the amount of pressure inside the pressurized canister and may be set to any desired pressure level such as 60 psi, 80 psi, 100 psi or the like.

The quick exhaust valve 96 may quickly exhaust pressure from the interior volume 13 of the pressure canister 12 when a user of the pneumatic spray gun 10 releases the trigger 45 to stop a spraying operation. Upon sensing a backpressure from the interior volume 13 of the pressure canister 12, the quick exhaust valve 96 can quickly dump the pressure to atmosphere. The quick exhaust valve 96 may release pressure/dump pressure to the atmosphere at different time delays based on the pressure supplied through the valve. The quick exhaust valve 96 dumps the back pressure in less than 0.1 second, or less than 0.01 second. The quick exhaust valve 96 may thus prevent unwanted discharge of excess texture material M from the dispensing tip D and nozzle insert 27 of the pneumatic gun 10 at the end of a spraying operation.

As shown in FIG. 19, a first pressurized air delivery line 80 is connected to the first pressurized air outlet 57 of the valve assembly 50, and to a nozzle inlet fitting 83 that feeds into the nozzle assembly 20. A pressurized air passage 84 in the nozzle and a nozzle outlet tube 85 are in flow communication with the first pressurized air delivery line 80 through the nozzle inlet fitting 83. An outlet orifice is provided in an air nozzle from which pressurized air from the first pressurized air delivery line 80 impacts texture material M flowing inside the cylindrical sleeve 25 and outside the air nozzle. The orifice has an opening diameter that is typically less than the diameter of the nozzle hole 28 of the nozzle insert 27, e.g., at least 25 or 50 percent less. For example, the diameter of the orifice may range from 1 to 3 mm, or from 1.2 to 1.8 mm. The pressurized air from the outlet orifice impacts the texture material M in the nozzle insert 27, thereby forcing the texture material M out through the nozzle hole 28 along with the pressurized air in a desired spray pattern.

The front face of the nozzle insert 27 extends an axial nozzle extension distance NA from the front face of the air nozzle. The front face of the air nozzle has a circular outer edge that is located radially inside a conical rear opening of the nozzle insert 27. A radial clearance distance NR is provided between the circular outer edge of the air nozzle front face and the circular inner edge of the rear conical opening of the nozzle insert 27. The axial distance NA and radial distance NR may be controlled to provide desired air pressure zones or pressure gradients in the interior region of the nozzle tip 27 during spraying operations, e.g., to avoid unwanted backpressure on the texture material M as it flows from the dispensing tip D. For example, the ratio of NA:NR may range from 1:1 to 15:1 or from 1.5:1 to 10:1, or from 2:1 to 5:1. The axial distance NA may range from 1 to 15 mm, or from 2 to 12 mm, or from 3 to 11 mm, and the radial distance NR may range from 1 to 10 mm, or from 1.5 to 5 mm, or from 2 to 3 mm.

The pressurized air source may comprise any conventional source such as an air compressor, installed pressure line, pressurized air tank, or the like. The air pressure provided from the pressurized air source may typically range from 5 psi to 100 or 140 psi for example, from 10 to 80 psi or from 25 to 70 psi. The air pressure from the pressurized source may be constant or may be adjustable by the user.

When spraying textured material M such as drywall formulations, the air pressure of the first pressurized air applied to the spray nozzle assembly 20 may typically be 20 psi or greater, and 140 psi or less. For example, the first pressure may range from 20 psi to 100 psi, or from 25 psi to 90 psi, or from 30 to 80 psi, or from 35 psi to 70 psi when spraying textured drywall formulations.

The air pressure of the second pressurized air supplied to the interior volume 13 of the pressure canister 12 is controlled to a level that forces the material M contained in the tube T through the dispensing tip D at a desired flow rate to produce a desired spray pattern. For example, when using the spray gun 10 to spray textured drywall, the second pressure in the interior volume 13 of the canister body 12 may typically be 1 psi or greater, and 50 psi or less. For example, the pressure may range from 1 psi to 30 or 40 psi, or from 2 psi to 20 psi, or from 3 psi to 15 psi.

The pressure regulator 55 or the like may be used to apply a different pressure to the interior volume 13 of the pressure canister 12 than the pressure applied to the nozzle assembly 20. For example, the air pressure of the second pressurized air applied to the interior volume 13 of the pressure canister 12 may be less than the pressure of the first pressurized air applied to the nozzle assembly 20. Typically, the second air pressure applied to the interior volume 13 of the pressure canister 12 may be at least 1 percent less than the first air pressure applied to the nozzle assembly 20, for example, at least 5 percent less, or at least 10 or 20 percent less, or at least 33 percent less, or at least 50 or 70 percent less. The pressure of the second pressurized air is from 1 to 99 percent less than the first pressurized air, or from 3 to 70 percent less. The pressure of the second pressurized air is from 1 to 139 psi less than the pressure of the first pressurized air, for example, from 2 to 99 psi less, or from 3 to 70 psi less, or from 4 to 50 or 60 psi less, or from 5 to 30 or 40 psi less.

The initiation and termination of the first air spray pressure provided through the first pressurized air delivery line 80, and the second material discharge pressure provided through the second pressurized air delivery line 90 are controlled. An initial delay time between flow of the first and second pressurized air streams is at least 0.01 second, for example, from 0.1 to 20 seconds, or from 1 to 5 seconds. The ending delay time between stopping of the second and first pressurized air flows is at least 0.05 second, for example, from 0.1 to 5 seconds, or from 1 to 3 seconds. As described above, the initial delay and end delay may be achieved by the differential axial lengths of the first and second actuator plungers 68 and 69. When a user initially squeezes the trigger 45 from its closed position, the first actuator plunger 68 moves the first valve plunger 61 toward its open position, followed by the second valve plunger 69 moving the second valve plunger 71 toward its open position, thereby creating the initial delay time. When a user releases the trigger 45 from its open position, the second valve plunger 71 closes first, followed by closing of the first valve plunger 61, thereby creating the ending delay time.

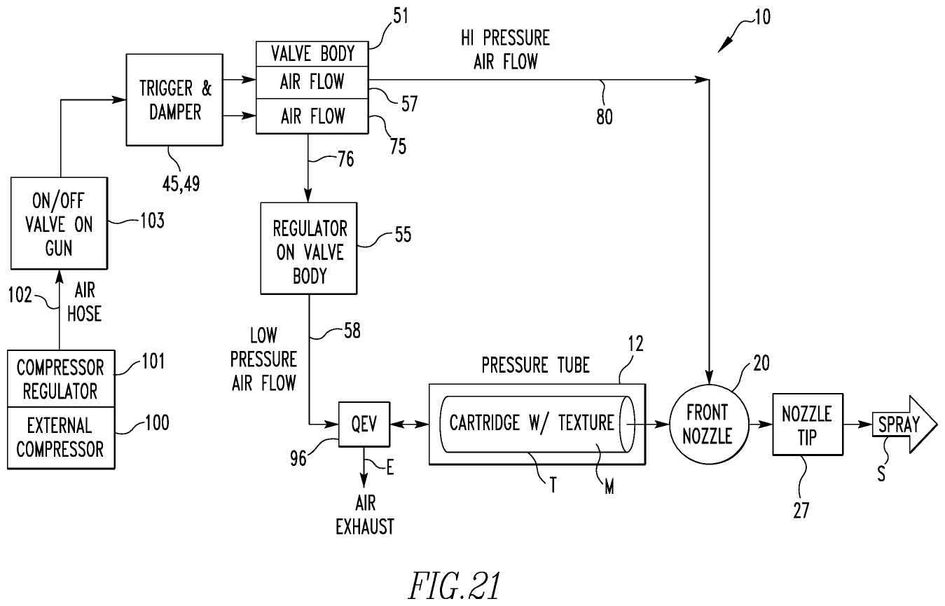

FIG. 21 schematically illustrates operation of a pneumatic spray gun 10 in accordance with the present invention. As described above, the pneumatic spray gun 10 includes a pressure canister 12 containing a cartridge or tube T of texture material M. The texture material M flows through the front nozzle 20 and nozzle tip 27. The first pressurized air delivery line 80 delivers pressurized air to the front nozzle 20 where it contacts the texture material M as it flows from the pressure tube 12. The combined texture material M and pressurized air are sprayed from the nozzle tip 27 in a spray pattern S.

As further shown in FIG. 21, a pressure source such as an exterior compressor 100 having a compressor regulator 101 feeds pressurized air through an air hose 102. An on/off switch 103 is used to control the flow of pressurized air into the valve body 51 under the control of the trigger 45 and damper assembly 49, as described above. When the trigger 45 is moved from its closed position toward an open position, the first stream of pressurized air initially flows through the front pressurized air outlet 57 for delivery to the front nozzle assembly 20 via the first pressurized air delivery line 80. After a short initial delay time as described above, the second pressurized air flows through the passages 75 and 76 to the pressure regulator 55, where the regulated pressure level may be reduced to a desired level, as described above. The regulated second pressurized air flows through the second pressurized air outlet 58 through the quick exhaust valve 96 and into the interior volume of the pressure canister 12. As further illustrated in FIG. 20, the quick exhaust valve 96 quickly dumps exhaust air E at the end of a spraying operation if backpressure builds up inside the interior volume 13 of the pressure canister 12. When the user releases the trigger 45 from its open position, the first and second biasing springs 63 and 73 act to move the trigger 45 toward its closed position, at which time its lower tip 47 comes into contact with the damper 49 to thereby slow the movement of the trigger 45 and its contact surface 44 as the trigger 45 moves to its closed position.

For purposes of the description above, it is to be understood that the invention may assume various alternative variations and step sequences except where expressly specified to the contrary. Moreover, other than in any operating examples, or where otherwise indicated, all numbers expressing, for example, quantities of ingredients used in the specification and claims, are to be understood as being modified in all instances by the term “about”. Accordingly, unless indicated to the contrary, the numerical parameters set forth are approximations that may vary depending upon the desired properties to be obtained by the present invention. At the very least, and not as an attempt to limit the application of the doctrine of equivalents, each numerical parameter should at least be construed in light of the number of reported significant digits and by applying ordinary rounding techniques.

It should be understood that any numerical range recited herein is intended to include all sub-ranges subsumed therein. For example, a range of “1 to 10” is intended to include all sub-ranges between (and including) the recited minimum value of 1 and the recited maximum value of 10, that is, having a minimum value equal to or greater than 1 and a maximum value of equal to or less than 10.

In this application, the use of the singular includes the plural and plural encompasses singular, unless specifically stated otherwise. In addition, in this application, the use of “or” means “and/or” unless specifically stated otherwise, even though “and/or” may be explicitly used in certain instances. In this application, the articles “a,” “an,” and “the” include plural referents unless expressly and unequivocally limited to one referent.

For purposes of the detailed description, it is to be understood that the invention may assume various alternative variations and step sequences, except where expressly specified to the contrary. Moreover, other than in any operating examples, or where otherwise indicated, all numbers such as those expressing values, amounts, percentages, ranges, subranges and fractions may be read as if prefaced by the word “about,” even if the term does not expressly appear. Accordingly, unless indicated to the contrary, the numerical parameters set forth in the following specification and attached claims are approximations that may vary depending upon the desired properties to be obtained by the present invention. At the very least, and not as an attempt to limit the application of the doctrine of equivalents to the scope of the claims, each numerical parameter should at least be construed in light of the number of reported significant digits and by applying ordinary rounding techniques. Where a closed or open-ended numerical range is described herein, all numbers, values, amounts, percentages, subranges and fractions within or encompassed by the numerical range are to be considered as being specifically included in and belonging to the original disclosure of this application as if these numbers, values, amounts, percentages, subranges and fractions had been explicitly written out in their entirety.

Notwithstanding that the numerical ranges and parameters setting forth the broad scope of the invention are approximations, the numerical values set forth in the specific examples are reported as precisely as possible. Any numerical value, however, inherently contains certain errors necessarily resulting from the standard variation found in their respective testing measurements.

As used herein, “including,” “containing” and like terms are understood in the context of this application to be synonymous with “comprising” and are therefore open-ended and do not exclude the presence of additional undescribed or unrecited elements, materials, ingredients or method steps. As used herein, “consisting of” is understood in the context of this application to exclude the presence of any unspecified element, ingredient or method step. As used herein, “consisting essentially of” is understood in the context of this application to include the specified elements, materials, ingredients or method steps “and those that do not materially affect the basic and novel characteristic(s)” of what is being described.

Whereas particular embodiments of this invention have been described above for purposes of illustration, it will be evident to those skilled in the art that numerous variations of the details of the present invention may be made without departing from the invention as defined in the appended claims.

What is claimed is:

1. A cartridge for containing and dispensing texture materials from a texture material spray gun, the cartridge comprising:
a generally cylindrical hollow cartridge body; and
a cartridge tip extending forwardly along a longitudinal axis from the cartridge body comprising at least one radially projecting rib or at least one radially indented recess structured and arranged to inhibit rotation of the cartridge tip around the longitudinal axis when the cartridge is mounted in the texture material spray gun.

2. The cartridge of claim 1, wherein the cartridge tip comprises a generally cylindrical body and a front portion extending forwardly from the body.

3. The cartridge of claim 2, wherein the at least one radially projecting rib or at least one radially indented recess are located in the front portion.

4. The cartridge of claim 1, comprising at least one of the radially projecting ribs and at least one of the radially indented recesses circumferentially spaced from the at least one radially projecting ribs and a circumference of the cartridge tip.

5. The cartridge of claim 1, comprising at least two of the radially projecting ribs and at least two of the radially indented recesses circumferentially spaced from the at least two radially projecting ribs and a circumference of the cartridge tip.

6. The cartridge of claim 1, comprising at least four of the radially projecting ribs and at least four of the radially indented recesses circumferentially spaced from the at least four radially projecting ribs around a circumference of the cartridge tip.

7. The cartridge of claim 6, wherein each of the radially projecting ribs tapers radially inward toward a front dispensing tip.

8. The cartridge of claim 6, wherein each of the radially projecting ribs comprises side channel walls extending along a length of the front portion and extending radially inward toward adjacent ones of the radially indented recesses.

9. The cartridge of claim 6, wherein each of the radially indented recesses comprises a rear wall.

10. The cartridge of claim 9, wherein each of the rear walls of the radially indented recesses transitions into side channel walls of adjacent ones of the radially projecting ribs that extend along a length of the front portion.

11. A pneumatic spray gun nozzle assembly for dispensing texture material, the assembly comprising:
a spray nozzle including a contoured central nozzle opening;
an air nozzle structured and arranged to direct pressurized air toward the texture material as the texture material passes through the spray nozzle; and
a cartridge including a contoured cartridge tip insertable in the contoured central nozzle opening,
wherein the contoured central nozzle opening comprises at least one retaining recess receiving at least one radially projecting rib of the contoured cartridge tip, or the contoured central nozzle opening comprises at least one retaining rib received within at least one radially indented recess of the cartridge tip, whereby relative rotational movement of the contoured cartridge tip within the contoured central nozzle opening is inhibited by the at least one radially projecting rib received in the at least one retaining recess of the contoured nozzle opening, or by the at least one retaining rib received within the at least one radially indented recess of the contoured cartridge tip.

12. The assembly of claim 11, wherein the contoured central nozzle opening comprises at least two of the retaining recesses and the contoured nozzle tip comprises at least two of the radially projecting ribs.

13. The assembly of claim 11, wherein the contoured central nozzle opening comprises at least two of the retaining ribs and the contoured nozzle tip comprises at least two of the radially indented recesses.

14. The assembly of claim 11, wherein the contoured central nozzle opening comprises four of the retaining recesses and four of the retaining ribs, and the contoured nozzle tip comprises four of the radially projecting ribs and four of the radially indented recesses.

15. A pneumatic spray gun for dispensing texture material, the pneumatic spray gun comprising:
a pressure canister including an interior volume structured and arranged to receive a cartridge containing the texture material;
a spray nozzle adjacent a front end of the pressure canister structured and arranged to receive the texture material when the texture material is dispensed from the cartridge; and
an air nozzle structured and arranged to direct pressurized air toward the texture material as the texture material passes through the spray nozzle,
wherein the spray nozzle comprises a contoured central nozzle opening comprising at least one retaining recess or at least one retaining rib structured and arranged to engage a contoured tip of the cartridge to thereby inhibit relative rotational movement between the contoured cartridge tip and the contoured central nozzle opening.
